(19) United States
(12) Patent Application Publication
(10) Pub. No.: US 2016/0171674 A1
(43) Pub. Date: Jun. 16, 2016

(54) INSPECTION METHOD AND INSPECTION APPARATUS

(71) Applicant: NuFlare Technology, Inc., Yokohama-shi (JP)

(72) Inventors: Hideo TSUCHIYA, Setagaya-ku (JP); Nobutaka KIKUIRI, Koganei-shi (JP)

(73) Assignee: NuFlare Technology, Inc., Yokohama-shi (JP)

(21) Appl. No.: 14/953,993

(22) Filed: Nov. 30, 2015

(30) Foreign Application Priority Data
Dec. 15, 2014 (JP) 2014-252961

(51) Int. Cl. G06T 7/00; G06K 9/03

(52) U.S. Cl. CPC G06T 7/001; G06T 7/0044; G06K 9/036; G06T 2207/30148

(57) ABSTRACT

An inspection apparatus according to embodiments includes a lightening unit, an imaging unit, a first storage unit, a comparison unit, and a first determination unit. The lighting unit irradiates a sample including a defect to be inspected with a lighting light. The imaging unit obtains an optical image formed by the lightening light transmitted through or reflected by the sample to be inspected. The first storage unit stores information on a defect correction method for the defect. The comparison unit compares the optical image and a reference image based on the information on the defect correction method. The first determination unit determines, based on a comparison result by the comparison unit and the information on the defect correction method, whether correction of the defect is appropriate.

### CROSS-REFERENCE TO RELATED APPLICATION

This application is based upon and claims the benefit of priority from Japanese Patent Applications No. 2014-252961, filed on Dec. 15, 2014, the entire contents of which are incorporated herein by reference.

### FIELD OF THE INVENTION

Embodiments described herein relate generally to an inspection apparatus and an inspection method. For example, the embodiments relate to an inspection apparatus and an inspection method for inspecting a pattern by obtaining an optical image of a pattern image by irradiating a sample to be inspected, such as a mask used to manufacture a semiconductor device, with a laser light.

### BACKGROUND OF THE INVENTION

Quality control of a circuit line width required in a semiconductor device is increasingly required in recent years. Such a semiconductor device is manufactured by forming a circuit by exposing and transferring a pattern on a wafer by a reduced projection exposure apparatus called a stepper by using an original pattern (called a mask or a reticle, and hereinafter collectively called a mask) in which a circuit pattern is formed. Therefore, a photolithography mask for transferring a fine circuit pattern on a wafer is manufactured by using a pattern drawing apparatus in which an electron beam is used. The pattern drawing apparatus can draw a fine circuit pattern. The pattern circuit apparatus can directly draw a pattern circuit on a wafer.

Improvement of yield is essential in manufacturing of LSI, such as a central processing unit (CPU) and a field programmable gate array (FPGA), requiring a high manufacturing cost. One of significant factors to reduce yield is a pattern defect of a photolithography mask used to expose and transfer an ultra fine pattern on a semiconductor wafer by a photolithography technique. In recent years, as the size of an LSI pattern formed on a semiconductor wafer is miniaturized, a size to be detected as a pattern defect is significantly reduced. Therefore, a highly accurate pattern inspection apparatus to inspect defect of a transfer mask used in LSI manufacturing is expected.

As an inspection method, an inspection method is known in which an optical image, in which a pattern formed on a sample such as a photolithography mask is imaged at a predetermined magnification, and design data or an optical image, in which a same pattern on the sample is imaged, are compared by using an expansion optical system. Examples of a pattern inspection method include a “die-to-die inspection” and a “die-to-database inspection”. In the die-to-die inspection, data of optical images in which a same pattern is imaged at different locations on the same mask are compared. In the die-to-database inspection, drawing data (pattern data), in which pattern-designed CAD data is converted into an apparatus input format to be input by a drawing apparatus when a pattern is drawn to a mask, is input to an inspection apparatus, design image data (a reference image) is generated based on the drawing data, and the design image data and an optical image formed by the pattern and being measurement data are compared. In an inspection method in such an inspection apparatus, a sample is arranged on a stage and inspected by which a beam scans on the sample when the stage is moved. The sample is irradiated with the beam by a light source and a lighting optical system. A light transmitted through or reflected by the sample is imaged on a light detector via the optical system. An image formed by the light detector is sent to a comparison circuit as measurement data. In the comparison circuit, after images are positioned each other, measurement data and reference data are compared in accordance with an appropriate algorithm. In the case of nonconformity, it is determined that a pattern is defective.

A defect correction method for a defect determined by a pattern inspection is diversified. Conventionally, the following methods are used as a correction method: a method in which a pattern is removed by spattering by a focused ion beam (FIB); a method in which a metal film is deposited by a laser chemical vapor deposition (laser CVD); and a method in which an amorphous carbon film is deposited as a pattern by the FIB or an electron beam. The Japanese Patent application Publication No. 2012-022323 discloses a method for correcting a transfer image of a photolithography mask by changing a transmittance of a substrate including a pattern of the photolithography mask, by femtosecond laser pulse.

As described above, since a defect inspection method and a defect correction method are diversified, an inspection apparatus and an inspection method are needed which can inspect a photolithography mask preventing excessive detection of a defect based on a defect correction method for the defect.

### SUMMARY OF THE INVENTION

An inspection apparatus according to embodiments includes a lightening unit, an imaging unit, a first storage unit, a comparison unit, and a first determination unit. The lighting unit irradiates a sample including a defect to be inspected with a lighting light. The imaging unit obtains an optical image formed by the lightening light transmitted through or reflected by the sample to be inspected. The first storage unit stores information on a defect correction method for the defect. The comparison unit compares the optical image and a reference image based on the information on the defect correction method. The first determination unit determines, based on a comparison result by the comparison unit and the information on the defect correction method, whether correction of the defect is appropriate.

The inspection method according to the embodiments includes: irradiating a sample including a defect to be inspected with a lighting light; obtaining either or both of a first optical image formed by the lightening light transmitted through the sample to be inspected and a second optical image formed by the lighting light reflected by the sample to be inspected; comparing a first reference image referenced from an optical image formed by the lighting light transmitted through the sample to be inspected and the first optical image or comparing a second reference image referenced from an optical image formed by the lighting light reflected by the sample to be inspected and the second optical image; determining whether defect correction of the defect is needed; determining a defect correction method for the defect; storing information on a defect correction method for the defect; correcting the defect by using the defect correction method; irradiating the sample to be inspected with a lighting light; obtaining either or both of a third optical image formed by the lighting light transmitted through the sample to be inspected and a fourth optical image formed by the lighting light reflected by the sample to be inspected; comparing the first reference image and the third optical image or comparing the second reference image and the fourth optical image, based on the information on the defect correction method; and determining, based on a result of the comparison and the information on the defect correction method, whether the correction is appropriate.

### BRIEF DESCRIPTION OF THE DRAWINGS

FIG. 1 is a schematic view of a main portion of an inspection apparatus according to a first embodiment;

FIGS. 2A to 2D are schematic views illustrating a cross section of an optical image formed by a lighting light transmitted through a mask corrected to reduce a transmittance of a substrate according to the first embodiment;

FIG. 3 is a schematic view of a main portion of an apparatus for inspecting a mask including a defect according to the first embodiment;

FIG. 4 is a schematic view of a main portion of the apparatus for inspecting a mask in which a defect has been corrected according to the first embodiment;

FIG. 5 is a flowchart of a method for inspecting a mask according to the first embodiment;

FIG. 6 is a schematic view of a main portion of an apparatus for inspecting a mask in which a defect has been corrected according to a second embodiment; and

FIG. 7 is a schematic view of a main portion of an apparatus for inspecting a mask in which a defect has been corrected according to a third embodiment.

### DETAILED DESCRIPTION OF THE EMBODIMENTS

Embodiments will be described below with reference to the drawings.

Hereinafter, a photolithography mask (a sample to be inspected) will be simply called a mask.

### First Embodiment

An inspection apparatus according to a first embodiment includes a lightening unit, an imaging unit, a first storage unit, a comparison unit, and a first determination unit. The lighting unit irradiates a sample including a defect to be inspected with a lighting light. The imaging unit obtains an optical image formed by the lightening light transmitted through or reflected by the sample to be inspected. The first storage unit stores information on a defect correction method for the defect. The comparison unit compares the optical image and a reference image based on the information on the defect correction method. The first determination unit determines, based on a comparison result by the comparison unit and the information on the defect correction method, whether correction of the defect is appropriate.

An inspection method according to the embodiment includes: irradiating a sample including a defect to be inspected with a lighting light; obtaining either or both of a first optical image formed by the lightening light transmitted through the sample to be inspected and a second optical image formed by the lighting light reflected by the sample to be inspected; comparing a first reference image referenced from an optical image formed by the lighting light transmitted through the sample to be inspected and the first optical image or comparing a second reference image referenced from an optical image formed by the lighting light reflected by the sample to be inspected and the second optical image; determining whether defect correction of the defect is needed; determining a defect correction method for the defect; storing information on a defect correction method for the defect; correcting the defect by using the defect correction method; irradiating the sample to be inspected with a lighting light; obtaining either or both of a third optical image formed by the lighting light transmitted through the sample to be inspected and a fourth optical image formed by the lighting light reflected by the sample to be inspected;

comparing the first reference image and the third optical image or comparing the second reference image and the fourth optical image, based on the information on the defect correction method; and determining, based on a result of the comparison and the information on the defect correction method, whether the correction is appropriate.

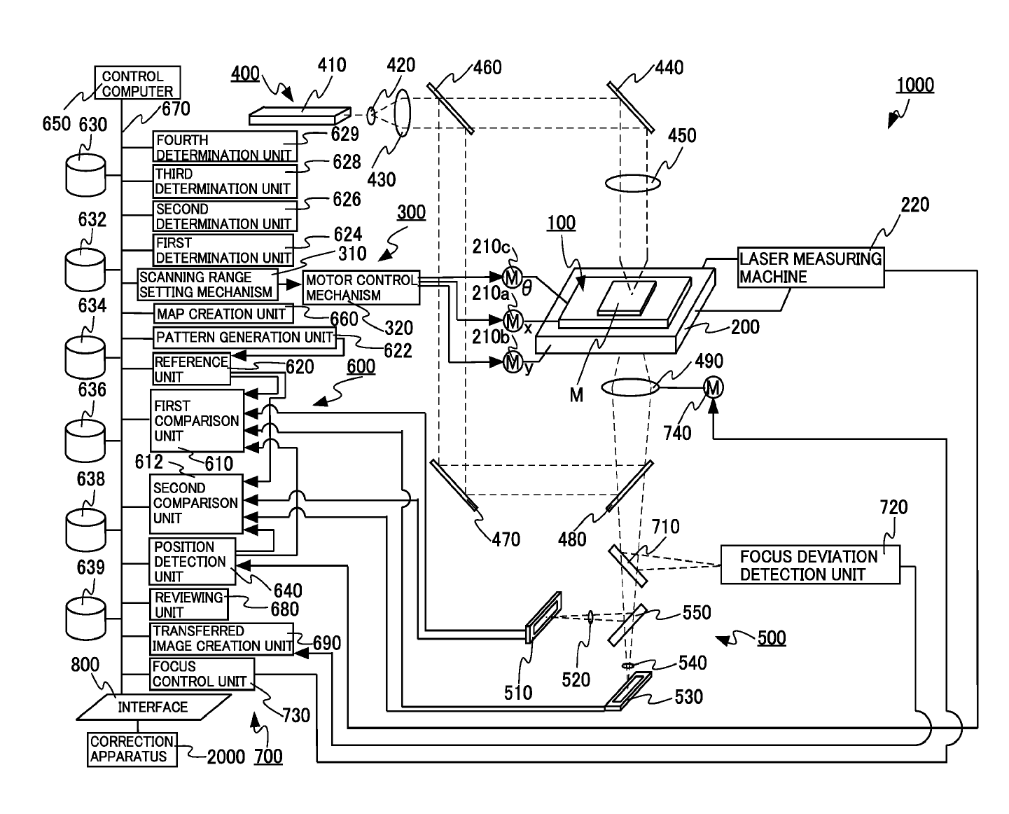

FIG. 1 is a schematic view of an inspection apparatus 1000 according to the first embodiment. The inspection apparatus according to the embodiment is a pattern inspection apparatus to inspect a defect in a mask.

A mask M is arranged in a storage 100.

A stage 200 is disposed under the storage 100 and supports the storage 100. The stage 200 is moved in an X direction and a Y direction, which are mutually orthogonal horizontal directions, by a first motor 210a and a second motor 210b, respectively. Further, the stage 200 is rotated by a third motor 210c on a surface perpendicular in a vertical direction. A laser measuring machine 220 measures positions of the stage 200 in the X direction and in the Y direction.

A moving control unit 300 includes a scanning range setting mechanism 310 and a motor control mechanism 320. The scanning range setting mechanism 310 is connected to a control computer 650 to be described later via a bus line 670. The motor control mechanism 320 controls the first motor 210a, the second motor 210b, and the third motor 210c so that the stage 200 is moved within a scanning range set by the scanning range setting mechanism 310.

A lighting unit 400 includes a light source 410, a lens 420 for a first lighting unit, a lens 430 for a second lighting unit, a mirror 440 for the first lighting unit, a condenser lens 450, a beam distribution device 460 for the first lighting unit, and a mirror 470 for the second lighting unit, a beam distribution device 480 for the second lighting unit, and an objective lens 490.

A lighting light such as a laser light emitted from the light source 410 is expanded so as to become a parallel beam by the lens 420 for the first lighting unit and the lens 430 for the second lighting unit. The mirror 440 for the first lighting unit and the condenser lens 450 irradiate a glass surface of the mask M with the expanded beam. The lens 420 for the first lighting unit, the lens 430 for the second lighting unit, the mirror 440 for the first lighting unit, and the condenser lens 450 form a light transmitting system. A wavelength of the light source 410 is preferably similar to a wavelength of a light source included in an exposure apparatus in which the mask M is used, since the mask M can be inspected in the same state as that in which exposure is performed by using the mask M.

Further, a lighting light such as a laser light emitted from the light source 410 is reflected by the beam distribution device 460 for the first lighting unit disposed between the lens 430 for the second lighting unit and the mirror 440 for the first lighting unit after the lighting light is expanded so as to become a parallel beam by the lens 420 for the first lighting unit and the lens 430 for the second lighting unit. The mirror 470 for the second lighting unit and the beam distribution device 480 for the second lighting unit irradiate a film surface of the mask M with the lighting light reflected by the beam distribution device 460 for the first lighting unit. The beam distribution device 460 for the first lighting unit, the mirror 470 for the second lighting unit, and the beam distribution device 480 for the second lighting unit form a reflection lighting system. Specifically, a half mirror, a slit, and a polarization beam splitter are preferably used as the beam distribution device 460 for the first lighting unit and the beam distribution device 480 for the second lighting unit.

An imaging unit 500 includes a first light detector 510, a lens 520 for a first imaging unit, a second light detector 530, a lens 540 for a second imaging unit, and a separation mirror 550.

A lighting light with which a glass surface of the mask M is irradiated by the light transmitting system and which is transmitted through the mask M is called a transmitted light. In addition, a lighting light with which a film surface of the mask M is irradiated by the reflection lighting system and which is then reflected by the mask M is called a reflected light. The transmitted light and the reflected light enter the separation mirror 550 through the objective lens 490 and the beam distribution device 480 for the second lighting unit. The transmitted light is imaged by the first light detector 510 through the lens 520 for the first imaging unit from the separation mirror 550. The reflected light is imaged by the second light detector 530 through the lens 540 for the second imaging unit from the separation mirror 550.

A control circuit 600 includes a first comparison unit (comparison unit) 610, a second comparison unit 612, a reference unit 620, a pattern generation unit 622, a first determination unit (determination unit) 624, a second determination unit 626, a third determination unit 628, a fourth determination unit 629, a pattern data storage unit 630, a first storage unit 632, a second storage unit 634, a third storage unit 636, a fourth storage unit 638, a fifth storage unit 639, a position detection unit 640, the control computer 650, a map creation unit 660, the bus line 670, a reviewing unit 680, and a transferred image creation unit 690.

The map creation unit 660 creates a defect map of the mask M. Herein, examples of a defect of the mask M include roughness of a pattern edge of the mask M, distribution of a line width of the mask M (a CD map), and a position deviation of a pattern of the mask M (an REG map).

An auto focus unit 700 includes an auto focus beam distribution device 710, a focus deviation detection unit 720, a focus control unit 730, and a motor 740 for the auto focus unit.

The reflected light is entered into the focus deviation detection unit 720 by the auto focus beam distribution device 710. The focus deviation detection unit 720 detects a focus deviation level from the incident reflected light and inputs the focus deviation level to the focus control unit 730. The focus control unit 730 moves the objective lens 490 in a height direction by controlling the motor 740 for the auto focus unit based on the input focus deviation level, and the objective lens 490 is focused on the mask M. The stage 200 may be moved in a vertical direction. Specifically, a half mirror, a slit, and a polarization beam splitter are preferably used as the auto focus beam distribution device 710.

As a method for inspecting the mask M, for example, an X axis direction is set to a main scanning direction, and a Y axis direction is set to a sub scanning direction. A lighting light is scanned in the X axis direction by movement of the stage 200 in the X axis direction. A scanning position is moved at a predetermined pitch in the Y axis direction by movement of the stage 200 in the Y axis direction. However, a method for inspecting the mask M is not limited to the above-described method.

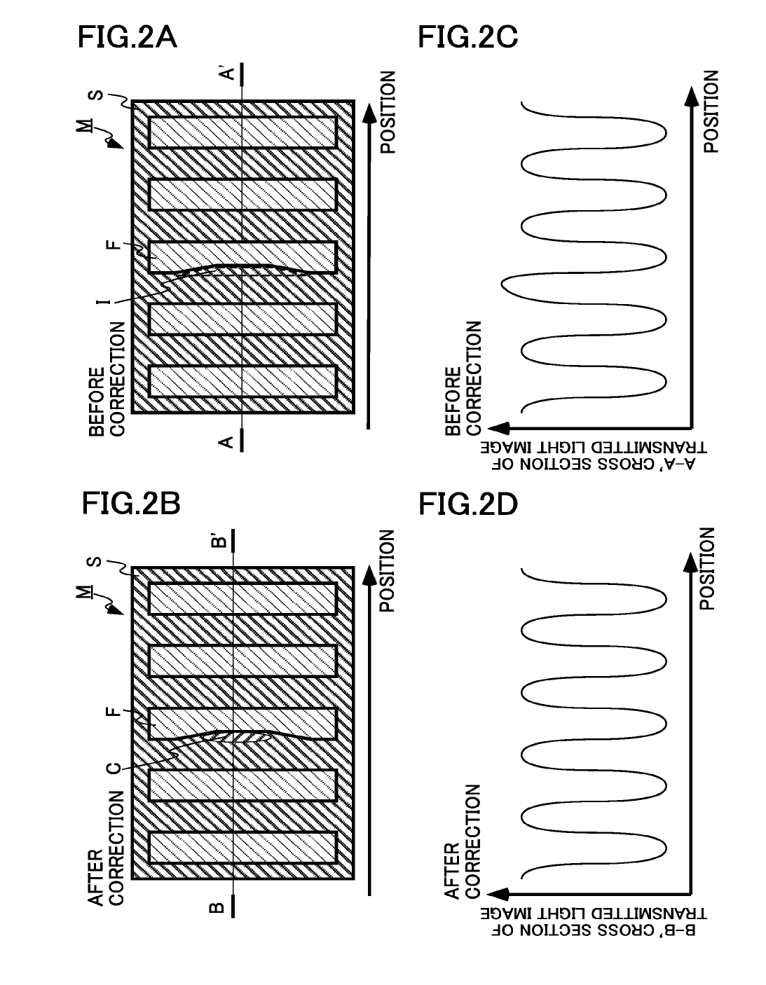

FIGS. 2A to 2D are schematic views illustrating a cross section of an optical image formed by a lighting light transmitted through the mask M corrected to reduce a transmittance of a substrate S according to the embodiment. The substrate S includes quarts. A shielding film F includes a thin film of metal such as chrome. The shielding film F forms a pattern. FIG. 2A illustrates a mask including a defect M. FIG. 2B illustrates the mask M in which the defect has been corrected. FIG. 2C is a transmitted light image on an A-A′ cross section of the mask including the defect M. FIG. 2D illustrates a transmitted light image on the B-B′ cross section of the mask M in which the defect has been corrected. The shielding film F illustrated at a center of FIG. 2A has a white defect I as a defect, and a part of the shielding film F is missed. In a portion in which the white defect is arranged, an amount of the transmitted light increases as illustrated in FIG. 2C, in comparison with a portion in which another shielding film F is disposed.

The mask M illustrated in FIG. 2B includes a portion C in which a transmittance of a substrate is reduced by melting the substrate around the white defect I by femtosecond laser pulse. Therefore, in FIG. 2D, the amount of a transmitted light is equalized on the periphery of a portion in which the central shielding film is disposed and on the periphery of a portion in which another shielding film is disposed. In this manner, a defect can be corrected. For example, a defect can be corrected so as to increase a transmittance by thinning a film thickness of the substrate S.

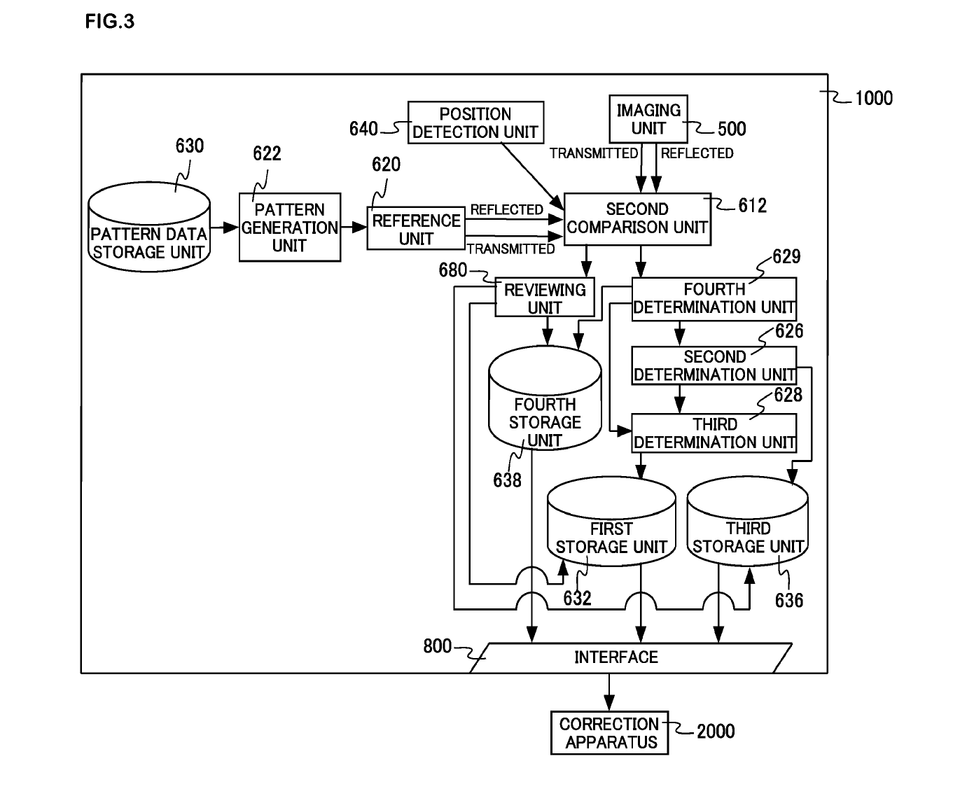

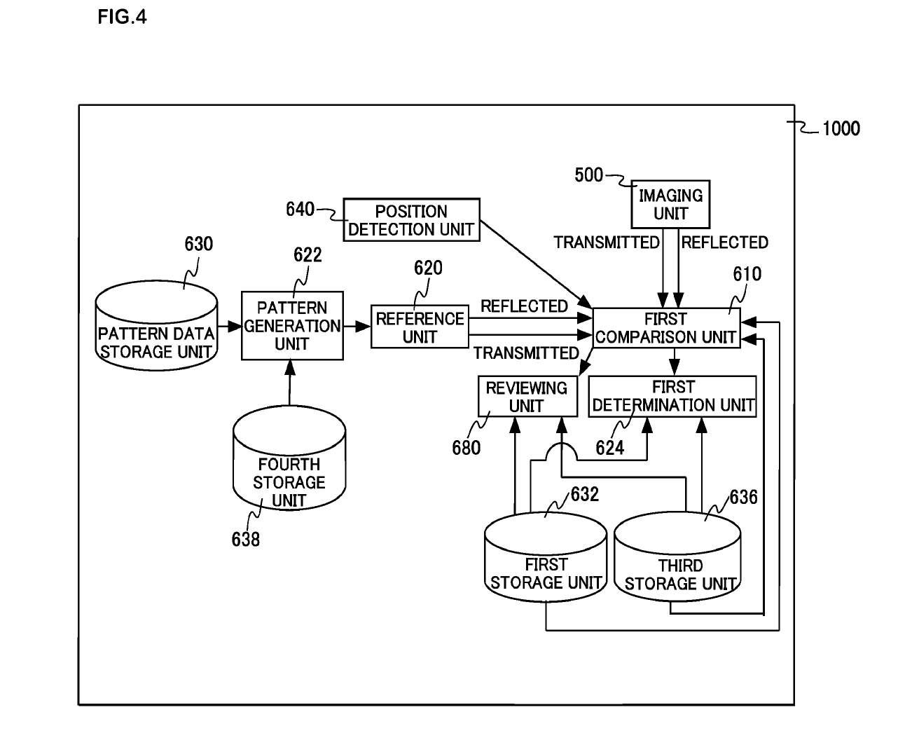

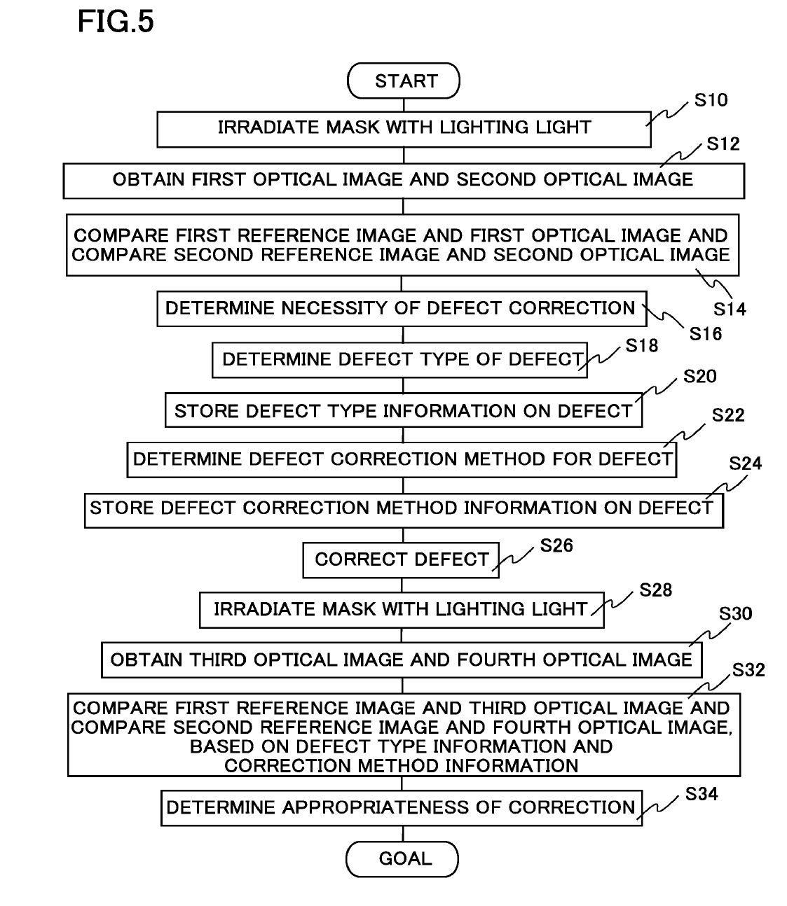

FIG. 3 is a schematic view of a main portion of an apparatus for inspecting a mask including a defect M according to the present embodiment. FIG. 4 is a schematic view of a main portion of the apparatus for inspecting the mask M in which a defect has been corrected, according to the present embodiment. FIG. 5 is a flowchart of a method for inspecting the mask M according to the present embodiment.

First, the control computer 650 irradiates the mask including the defect M with a lighting light by using the lighting unit 400 (S10). Then, a first optical image formed by the lighting light transmitted through the mask M and a second optical image formed by the lighting light reflected by the mask M are obtained by using the imaging unit 500 (S12). Either of the first optical image or the second optical image may be obtained. The obtained first and second optical images are sent to the second comparison unit 612.

Next, the control computer 650 inputs pattern data stored in the pattern data storage unit 630 to the pattern generation unit 622, and the pattern data is expanded to each layer. The pattern data is preliminarily prepared by a designer. Herein, the pattern data is generally not designed such that an inspection apparatus 1000 can directly read the data. Therefore, the pattern data is first converted into intermediate data created for each layer, and then converted into data formed so as to be directly read by each inspection apparatus 1000. After that, the pattern data is input to the pattern generation unit 622.

Next, by using the reference unit 620, the control computer 650 creates either or both of a first reference image and a second reference image from the pattern data expanded to each layer by the pattern generation unit 622. The first reference image is referenced from an optical image formed by a lighting light transmitted through the mask M. The second reference image is referenced from an optical image formed by a lighting light reflected by the mask M.

Next, by using the second comparison unit 612, the control computer 650 compares the first reference image and the first optical image and compares the second reference image and the second optical image (S14). Depending on a defect type, one of the comparison between the first reference image and the first optical image and the comparison between the second reference image and the second optical image may be performed. An example of a comparison method herein includes a method for comparing an amount of the transmitted light in a pattern portion of the first optical image and an amount of the transmitted light in a pattern portion of the corresponding first reference image. The example also includes a method for comparing an amount of the reflected light in a pattern portion of the second optical image and an amount of the reflected light in a pattern portion of the corresponding second reference image.

The first optical image and the first reference image or the second optical image and the second reference image are sent to the reviewing unit 680 and reviewed by an operator. Herein, “review” means a comparison operation between an optical image and a reference image by an operator.

Defect coordinates of the mask M requested by the position detection unit 640 are input to the first comparison unit 610, the second comparison unit 612, and the reviewing unit 680. The position detection unit 640, for example, measures a relative positional relationship between a mark referenced from an optical image of the mask M and a defect position and detects the defect position by indicating as relative coordinates. Herein, one of alignment marks disposed at four corners of an inspection region on the mask M and used in a plate rotation alignment is preferably defined for use as a reference mark.

Next, the fourth determination unit 629 or an operator determines, based on a comparison result by the second comparison unit 612, whether the mask M needs a defect correction (S16). An example of a determination method herein includes a method for determining the necessity based on a difference between an amount of the transmitted light in a pattern portion of the first optical image and an amount of the transmitted light in a pattern portion of the corresponding first reference image. The example also includes a method for determining the necessity based on a difference between an amount of the reflected light in a pattern portion of the second optical image and an amount of the reflected light in a pattern portion of the corresponding second reference image. In the present embodiment, the mask M includes the white defect I. Therefore, a defect correction is determined to be necessary by the comparison between the first reference image and the first optical image, and also determined to be necessary by the comparison between the second reference image and the second optical image.

Next, the second determination unit 626 or an operator determines a defect type of a defect of the mask M determined that a defect correction is needed (S18). Defect type information of the defect on the determined defect type is stored in the third storage unit 636 (S20). Herein, the defect type information of the defect is information indicating a defect type of the mask M and, for example, includes whether a defect is in a pattern form, a defect is in a pattern line width, or a defect is a pattern position deviation. Further, the information may include whether a defect is found in an optical image by the reflected light, or a defect is found in an optical image by the transmitted light. According to the present embodiment, a defect type of the defect is a white defect, and the defect type information of the defect is information that “a defect is a white defect”.

A defect correction method for the defect is determined by the third determination unit 628 or an operator (S22). Defect correction method information of the defect on the determined defect correction method is stored in the first storage unit 632 (S24). Herein, the defect correction method information includes information on a method for correcting a defect determined that the correction is needed. Examples of a defect correction method herein include: a defect correction method to reduce a transmittance of a substrate by melting a part of the substrate near the shielding film F by femtosecond laser pulse or the like; a defect correction method to increase a transmittance of the substrate by reducing a film thickness of the substrate; a defect correction method to remove an excessive shielding film F by a laser light or a focused ion beam (FIB); a defect correction method to remove the excessive shielding film F by FIB or an electron beam by making a part of the mask M locally into a corrosive gas atmosphere; a defect correction method to reduce the excessive shielding film F by a cutting edge of an AFM cantilever; a defect correction method to deposit a metal film by a laser chemical vapor deposition (laser CVD); and a defect correction method to deposit an amorphous carbon film by an FIB or an electron beam. A correction method according to the present embodiment is a method for reducing a transmittance of a substrate. Defect correction method information according to the embodiment includes information on the defect correction method to reduce a transmittance of the substrate.

Next, a fourth determination unit 629 or an operator creates a coordinate list of corrected portions, which includes coordinates of the mask M necessary for a correction, and the fourth storage unit 638 stores the list.

The coordinate list of corrected portions, the defect type information, and the defect correction method information are sent to a correction apparatus 2000 through an interface 800. The correction apparatus 2000 corrects a defect of the mask M by using the coordinate list of corrected portions, the defect type information, and the defect correction method information (S26).

Next, the control computer 650 irradiates the mask M with a lighting light by using the lighting unit 400 (S28). Then, the control computer 650 obtains, by using the imaging unit 500, a third optical image formed by the lighting light transmitted through the mask M and a fourth optical image formed by the lighting light reflected by the mask M (S30). Either of the third optical image or the fourth optical image may be obtained. The obtained third and fourth optical images are sent to the first comparison unit 610.

Next, by using the first comparison unit 610 and based on the coordinate list of corrected portions, the defect type information, the defect correction method information, the control computer 650 compares a first reference image and the third optical image and compares a second reference image and the fourth optical image (S32). One of the comparison between the first reference image and the third optical image and the comparison between the second reference image and the fourth optical image may be performed.

Further, the third optical image and the first reference image or the fourth optical image and the second reference image are sent to the reviewing unit 680 and reviewed by an operator.

In the present embodiment, the defect type information includes information that “a defect is a white defect”, and the defect correction method information includes information on “a defect correction method to reduce a transmittance of a substrate”. Therefore, both of an optical image by the transmitted light and an optical image by the reflected light are preferably compared with a reference image at a corrected portion. Accordingly, by using the first comparison unit 610, the control computer 650 compares the third optical image and the first reference image, and the fourth optical image and the second reference image by using coordinates of corrected portions.

Next, the first determination unit 624 or an operator determines, based on a comparison result by the first comparison unit 610, the defect type information, and the defect correction method information, whether a correction is appropriate (S34). In the present embodiment, a form of the shielding film F is not changed. Therefore, an optical image formed by a lighting light reflected by the mask M is not changed before and after a correction, and a defect is detected in the fourth optical image. On the other hand, an optical image formed by a lighting light transmitted through the mask M is changed before and after a correction, and a defect is not detected in the third optical image if the correction is appropriate. Therefore, in the present embodiment, if a defect is not detected in comparison between the first reference image and the third optical image, it is determined that a correction is appropriate even if a defect is detected in comparison between the second reference image and the fourth optical image.

Next, an effect of the present embodiment will be described.

A form of the shielding film F is not changed by a correction in which a transmittance of a substrate is changed, according to the present embodiment. Therefore, a change is not detected between an optical image formed by a lighting light reflected by the mask M before a defect correction and an optical image formed by the lighting light reflected by the mask M after the defect correction. Accordingly, if appropriateness of the correction is determined without using the defect type information and the defect correction method information, it is determined that the correction has been improperly performed and a defect might be excessively detected. As in the present embodiment, if a correction is determined based on the defect type information and the defect correction method information, excessive detection of a defect is prevented and the appropriateness of the correction can be properly determined.

In addition, when the defect type information is used, a reference image corresponding to one of the first and second optical images, in which a defect is supposedly detected, can be expanded by the pattern generation unit 622. Accordingly, a time for creating a reference image is reduced, and the mask M can be quickly inspected. Further, when image alignments of an optical image and a reference image are matched to compare the optical image and the reference image in a process to detect a defect, a portion including a defect is not used to match the image alignment by using the defect type information and the coordinate list of corrected portions. Thus, an optical image and a reference image can be more strictly compared. Especially, in the case where a line width is drastically widened or narrowed at the portion including the defect, image alignments are more precisely matched.

Further, when the defect type information is used, either of the first optical image or the second optical image, which corresponds to a lighting light determined to be defective, is compared with a reference image by using the first comparison unit 610. In this manner, the mask M can be quickly inspected. Further, if information whether a defect is in a pattern form, in a line width of a pattern, or position deviation of a pattern is input to the first comparison unit 610, an inspection procedure of the mask M can be omitted. Therefore, the mask M can be effectively inspected.

If the coordinate list of corrected portions is used, a material of a shielding film used in correction does not remain on the mask M as a fragment, unlike a method for removing an excessive pattern by spattering by an FIB, a method for depositing a metal film by a laser CVD, and a method for depositing an amorphous carbon film as a pattern by an FIB or an electron beam. Therefore, comparison between an optical image and a reference image in a predetermined size range around a coordinate portion determined as a defect is sufficient. In this manner, the mask M can be efficiently inspected. The above predetermined size range is, for example, about 10 μm to 1 mm, and can be properly set in accordance with a correction scale.

As described above, according to the inspection apparatus and the inspection method in the present embodiment, an inspection apparatus and an inspection method can be provided which can inspect a photolithography mask preventing excessive detection of a defect based on a defect correction method for a diversified photolithography mask.

### Second Embodiment

An inspection apparatus according to a second embodiment differs from the inspection apparatus according to the first embodiment in an aspect in respect of further including a transferred image creation unit configured to create a transfer image based on a transfer parameter and an optical image. The description of a point described in the first embodiment will be omitted herein.

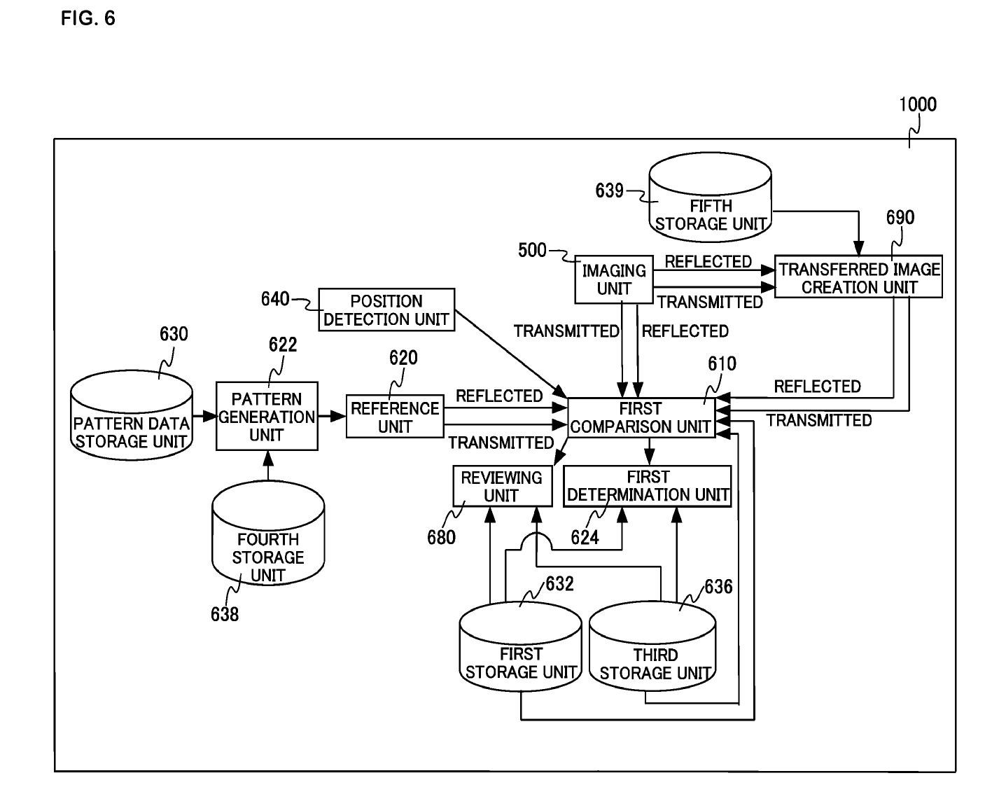

FIG. 6 is a schematic view of an apparatus for inspecting a mask in which a defect has been corrected according to the present embodiment.

Examples of a transfer parameter stored in a fifth storage unit 639 include a type of a light source used in exposure such as a point source light and a dipole light source, a wavelength used in exposure, or a number of openings in a lens used in exposure.

The transferred image creation unit 690 creates a transfer image in the case of transferring on a wafer if a mask in which a defect has been corrected is used, based on the above transfer parameter and an optical image obtained by the imaging unit 500. The created transfer image is sent to a first comparison unit 610 and used for reviewing by a reviewing unit 680.

In the present embodiment, it can be confirmed by a transfer image supposed to be transferred on a wafer whether a defect is sufficiently corrected. Accordingly, the propriety of correction can be specifically determined, and yield of the correction of a mask M can be improved.

As described above, according to the inspection apparatus in the present embodiment, an inspection apparatus and an inspection method can be provided which can inspect a photolithography mask preventing excessive detection of a defect based on a defect correction method for a diversified photolithography mask.

### Third Embodiment

An inspection apparatus according to a third embodiment differs from inspection apparatuses according to the first and second embodiments in respect of further including a second storage unit configured to store sensitivity specification data used in a comparison unit. The descriptions of points described in the first and second embodiments will be omitted herein.

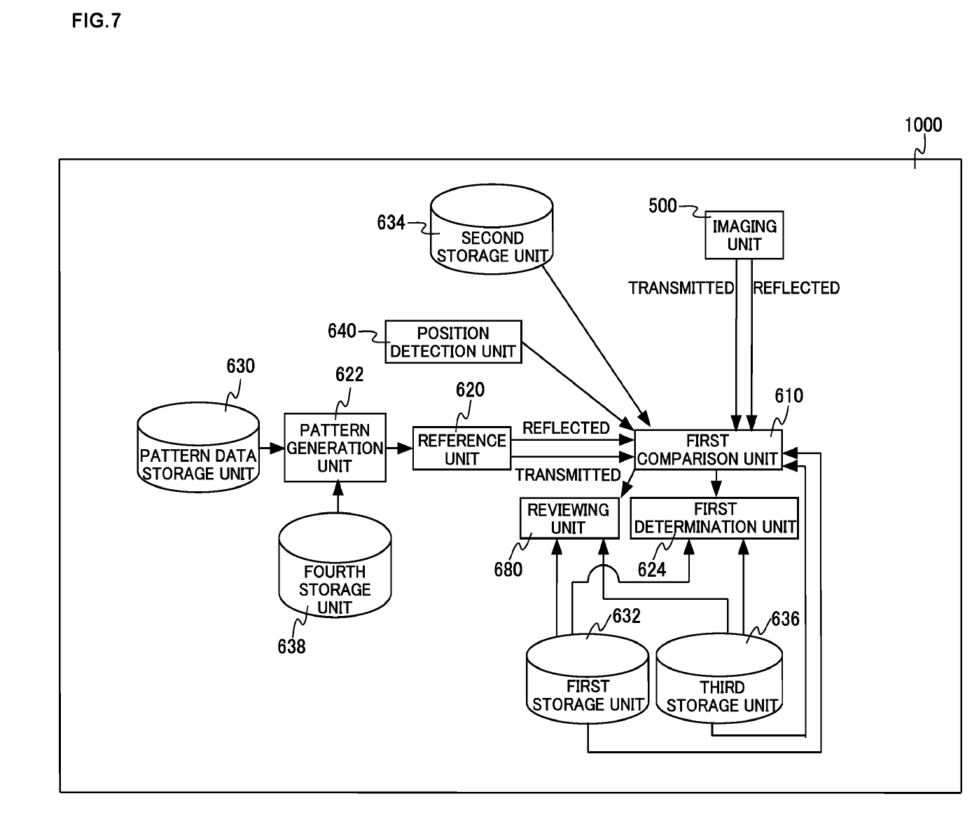

FIG. 7 is a schematic view of an apparatus for inspecting a mask in which a defect has been corrected according to the present embodiment.

A defect in a pattern which is not transferred on a wafer such as an assist bar and a defect in a dummy pattern for uniformly performing chemical mechanical polishing (CMP) may not be strictly determined in comparison with a defect in a pattern of such as a transistor or the like transferred on a wafer. Sensitivity specification data in portions in which the assist bar and the dummy pattern are disposed is determined so as to lower a sensitivity of defect determination. In this manner, the yield of the mask M can be improved.

Further, there is a case where a defect in a pattern form still remains although a defect in a line width and point deviation in a pattern have been corrected by the inspection apparatus according to the present embodiment. In this case, the form defect can be strictly determined by determining sensitivity specification data so as to increase a sensitivity of a defect determination.

According to the inspection apparatus in the present embodiment, an inspection apparatus and an inspection method can be provided which can inspect a photolithography mask preventing excessive detection of a defect based on a defect correction method for a diversified photolithography mask.

The inspection apparatus according to the present embodiment includes a lightening unit, an imaging unit, a first storage unit, a comparison unit, and a determination unit. The lighting unit irradiates a sample including a defect to be inspected with a lighting light. The imaging unit obtains an optical image formed by the lightening light transmitted through or reflected by the sample to be inspected. The first storage unit stores information on a defect correction method for the defect. The comparison unit compares the optical image and a reference image based on the information on the defect correction method. The determination unit determines, based on a comparison result by the comparison unit and the information on the defect correction method, whether correction of the defect is appropriate. Accordingly, an inspection apparatus can be provided which can inspect a photolithography mask preventing excessive detection of a defect based on a defect correction method for a diversified photolithography mask.

In the above description, process contents or operation contents in “the storage unit” can be configured by a program operable in a computer. Alternatively, in addition to a program being software, the contents may be performed by combining software and hardware. Alternatively, firmware may be combined. In addition, in the case where the content is configured by a program, the program is stored in a storage medium in a magnetic disc unit, a magnetic tape unit, a FD, a read-only memory (ROM), and a solid state drive (SSD), which are not illustrated.

The description regarding a portion which is not directly needed in a description of the present invention, such as a configuration, is omitted in the embodiments. However, a necessary configuration can be selected appropriately for use. Further, all of inspection apparatuses and inspection methods which include elements in the present invention and can be appropriately changed in design by a person skilled in the art are included in the scope of the present invention. The scope of the present invention is defined by the scope of claims and the equivalent scope thereof.

What is claimed is:

1. An inspection apparatus, comprising:
a lighting unit configured to irradiate a sample including a defect to be inspected with a lighting light;
an imaging unit configured to obtain an optical image formed by the lightening light transmitted through or reflected by the sample to be inspected;
a first storage unit configured to store information on a defect correction method for the defect;
a comparison unit configured to compare the optical image and a reference image based on the information on the defect correction method; and
a first determination unit configured to determine, based on a comparison result by the comparison unit and the information on the defect correction method, whether correction of the defect is appropriate.

2. The inspection apparatus according to claim 1, further comprising:
a transfer image creation unit configured to create a transfer image based on a transfer parameter and the optical image.

3. The inspection apparatus according to claim 1, further comprising:
a second storage unit configured to store sensitivity specification data used in the comparison unit.

4. The inspection apparatus according to claim 1, further comprising:
a third storage unit configured to store defect type information of the defect,
wherein the comparison unit further compares the optical image and the reference image based on the defect type information, and
the first determination unit further determines, based on the defect type information, whether correction of the defect is appropriate.

5. The inspection apparatus according to claim 1, further comprising:
a second determination unit configured to determine a defect type of the defect.

6. The inspection apparatus according to claim 1, further comprising:
a third determination unit configured to determine a defect correction method for the defect.

7. An inspection method, comprising:
irradiating a sample including a defect to be inspected with a lighting light;
obtaining either or both of a first optical image formed by the lightening light transmitted through the sample to be inspected and a second optical image formed by the lighting light reflected by the sample to be inspected;
comparing a first reference image referenced from an optical image formed by the lighting light transmitted through the sample to be inspected and the first optical image or comparing a second reference image referenced from an optical image formed by the lighting light reflected by the sample to be inspected and the second optical image;
determining whether defect correction of the defect is needed;
determining a defect correction method for the defect;
storing information on a defect correction method for the defect;
correcting the defect by using the defect correction method;
irradiating the sample to be inspected with a lighting light;
obtaining either or both of a third optical image formed by the lighting light transmitted through the sample to be inspected and a fourth optical image formed by the lighting light reflected by the sample to be inspected;
comparing the first reference image and the third optical image or comparing the second reference image and the fourth optical image, based on the information on the defect correction method; and
determining, based on a result of the comparison and the information on the defect correction method, whether the correction is appropriate.

8. The inspection method according to claim 7, wherein
the sample to be inspected comprises a substrate and a light shielding film disposed on the substrate,
the defect correction method is a method for reducing a transmittance of the substrate,
the information on the defect correction method is information on a method for reducing a transmittance of the substrate, and
the correction is determined to be appropriate when:
the defect is detected in comparison with the first reference image and the first optical image;
the defect is detected in comparison with the second reference image and the second optical image;
the defect is not detected in comparison with the first reference image and the third optical image; and
the defect is detected in comparison with the second reference image and the fourth optical image.

9. The inspection method according to claim 7, further comprising determining a defect type of the defect.

10. The inspection method according to claim 9, wherein the defect type is a white defect.
